(19) United States
(12) Patent Application Publication
(10) Pub. No.: US 2026/0343647 A1
(43) Pub. Date: Oct. 29, 2026

(54) METHOD AND APPARATUS FOR MULTI-SIM OPERATION

(71) Applicant: Telefonaktiebolaget LM Ericsson (publ), Stockholm (SE)

(72) Inventors: Zhixun TANG, Beijing (CN); Muhammad Ali KAZMI, Sundbyberg (SE); Alessio TERZANI, Stockholm (SE); Tahmineh TORABIAN ESFAHANI, Sollentuna (SE)

(21) Appl. No.: 19/116,182

(22) PCT Filed: Sep. 14, 2023
(86) PCT No.: PCT/SE2023/050900

§ 371 Date: Mar. 27, 2025

(30) Foreign Application Priority Data
Sep. 29, 2022 (WO) PCT/CN2022/122584

(51) Int. Cl. H04W 76/15; H04W 76/28; H04W 88/06

(52) U.S. Cl. CPC H04W 76/15; H04W 76/28; H04W 88/06

(57) ABSTRACT

Various embodiments of the present disclosure provide a method for multi-SIM operation. The method which may be performed by a terminal device comprises: obtaining information about a relation between a multi-carrier configuration (MCC) for the terminal device in a first network and a measurement gap configuration (MGC) for the terminal device for performing one or more procedures in a second network. In accordance with an exemplary embodiment, the method further comprises: transmitting the information about the relation between the MGC and the MCC to one or more network nodes.

### FIELD OF THE INVENTION

The present disclosure generally relates to communication networks, and more specifically, to a method and apparatus for multi-subscriber identity module (multi-SIM) operation.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE)/fourth generation (4G) network and new radio (NR)/fifth generation (5G) network are expected to achieve high traffic capacity and energy efficiency. For the purpose of obtaining satisfactory network services and communication quality, a terminal device such as a user equipment (UE) may be configured to support multi-SIM operation, so as to perform communications by using different universal subscriber identity modules (USIMs) or SIMs associated with the same network operator or different network operators.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The multi-USIM (MUSIM) enhancement proposed by the 3rd generation partnership project (3GPP) may enable a UE to be connected with a first network and a second network at the same time. In order to obtain services from the second network, the UE being served by the first network may require the first network to create some gaps for performing one or more procedures (e.g., measurements, monitoring paging, etc.) in the second network. Since there may be no data scheduled for the UE by the first network during the gaps, a long duration and/or a large number of the gaps may adversely affect communication performance (e.g., traffic throughput, service quality, etc.) of the UE in the first network. Therefore, it may be desirable to implement the use of gaps in a multi-USIM scenario more efficiently.

Various exemplary embodiments of the present disclosure propose a solution for multi-SIM operation, which may enable a tradeoff between a measurement gap configuration (MGC) and a multi-carrier configuration (MCC) for a terminal device capable of multi-SIM operation.

According to a first aspect of the present disclosure, there is provided a method performed by a terminal device (e.g., a UE, a mobile terminal, etc.). The method comprises: obtaining information about a relation between a MCC for the terminal device in a first network and a MGC for the terminal device for performing one or more procedures in a second network. In accordance with an exemplary embodiment, the method further comprises: transmitting the information about the relation between the MGC and the MCC to one or more network nodes.

In accordance with an exemplary embodiment, the one or more network nodes may comprise at least a network node of the first network.

In accordance with an exemplary embodiment, the terminal device may obtain the information about the relation between the MGC and the MCC by using predefined information, and/or by determining the information about the relation between the MGC and the MCC autonomously.

In accordance with an exemplary embodiment, the information about the relation between the MGC and the MCC may be transmitted as part of user equipment assistance information (UAI) to the one or more network nodes by the terminal device.

In accordance with an exemplary embodiment, the information about the relation between the MGC and the MCC may be transmitted by the terminal device to the one or more network nodes proactively, and/or in response to receiving one or more requests from the one or more network nodes, and/or when one or more criterions are met.

In accordance with an exemplary embodiment, the information about the relation between the MGC and the MCC may comprise one or more of: an identifier of predefined mapping between the MGC and the MCC; MGC information for one or more procedures in the second network; MCC information for one or more multi-carrier operations in the first network; timing information of the relation between the MGC and the MCC; and behavior information of the terminal device related to the timing information.

In accordance with an exemplary embodiment, the timing information of the relation between the MGC and the MCC may comprise one or more of the following parameters:
starting reference time when the relation between the MGC and the MCC is applicable;
a time period over which the relation between the MGC and the MCC is valid; and
ending reference time when the relation between the MGC and the MCC is no more applicable.

In accordance with an exemplary embodiment, the relation between the MGC and the MCC may be indicated by one or more of:
a mapping identifier indicating the relation between the MGC and the MCC;
an identifier of the MGC;
an identifier of the MCC;
a number of measurement gap patterns (MGPs) associated with the MGC;
a type of MGP;
a maximum number of component carriers (CCs) associated with the MCC;
a type of MCC;
a maximum number of bands associated with the MCC;
status information of one or more CCs associated with the MCC; and
status information of one or more bands associated with the MCC.

In accordance with an exemplary embodiment, the relation between the MGC and the MCC may be based at least in part on one or more of:
a discontinuous reception (DRX) cycle configuration with which the terminal device is expected to operate in the second network;
a type of a low activity radio resource control (RRC) state with which the terminal device is expected to operate in the second network;
whether the terminal device is expected to be configured with only DRX cycle or with extended discontinuous reception (eDRX) cycle in the second network; and
a measurement object configuration of the terminal device in the second network.

In accordance with an exemplary embodiment, the method according to the first aspect of the present disclosure may further comprise: providing configuration information per MGC to a network node of the first network explicitly or implicitly.

In accordance with an exemplary embodiment, the method according to the first aspect of the present disclosure may further comprise: determining that the terminal device is configured with one or more measurement objects on one or more carrier frequencies and/or one or more procedures in a cell of the second network.

In accordance with an exemplary embodiment, the method according to the first aspect of the present disclosure may further comprise: receiving MCC information from a network node of the first network.

In accordance with an exemplary embodiment, the method according to the first aspect of the present disclosure may further comprise: setting up one or more cells in the first network to perform one or more multi-carrier operations, according to the MCC information.

In accordance with an exemplary embodiment, the method according to the first aspect of the present disclosure may further comprise: transmitting, to a network node of the first network, a request for configuring the terminal device with one or more MGPs for one or more procedures in the second network.

In accordance with an exemplary embodiment, the method according to the first aspect of the present disclosure may further comprise: receiving MGC information from a network node of the first network.

In accordance with an exemplary embodiment, the method according to the first aspect of the present disclosure may further comprise: setting up one or more MGPs to perform one or more procedures in the second network, according to the MGC information.

In accordance with an exemplary embodiment, the terminal device may be capable of multi-USIM operation.

According to a second aspect of the present disclosure, there is provided an apparatus which may be implemented as a terminal device. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a terminal device. The apparatus may comprise an obtaining unit and a transmitting unit. In accordance with some exemplary embodiments, the obtaining unit may be operable to carry out at least the obtaining step of the method according to the first aspect of the present disclosure. The transmitting unit may be operable to carry out at least the transmitting step of the method according to the first aspect of the present disclosure.

According to a fifth aspect of the present disclosure, there is provided a method performed by a network node (e.g., a base station, an access point, etc.) of a first network. The method comprises: obtaining information about a relation between a MCC for a terminal device in the first network and a MGC for the terminal device for performing one or more procedures in a second network. In accordance with an exemplary embodiment, the method further comprises: performing one or more actions, according to the information about the relation between the MGC and the MCC.

In accordance with an exemplary embodiment, the relation between the MGC and the MCC according to the fifth aspect of the present disclosure may correspond to the relation between the MGC and the MCC according to the first aspect of the present disclosure. Thus, the relation between the MGC and the MCC according to the first and fifth aspects of the present disclosure may have the same or similar contents and/or feature elements.

In accordance with an exemplary embodiment, the information about the relation between the MGC and the MCC according to the fifth aspect of the present disclosure may correspond to the information about the relation between the MGC and the MCC according to the first aspect of the present disclosure. Thus, the information about the relation between the MGC and the MCC according to the first and fifth aspects of the present disclosure may have the same or similar contents and/or feature elements.

In accordance with an exemplary embodiment, the one or more actions may comprise: applying one or more MGCs to the terminal device to enable the terminal device to perform one or more procedures in the second network; and/or applying one or more MCCs to the terminal device to enable the terminal device to perform one or more multi-carrier operations in the first network.

In accordance with an exemplary embodiment, the network node may obtain the information about the relation between the MGC and the MCC by using predefined information, and/or by receiving the information about the relation between the MGC and the MCC from the terminal device.

In accordance with an exemplary embodiment, the information about the relation between the MGC and the MCC may be received as part of UAI by the network node from the terminal device.

In accordance with an exemplary embodiment, the method according to the fifth aspect of the present disclosure may further comprise: obtaining configuration information per MGC from the terminal device explicitly or implicitly.

In accordance with an exemplary embodiment, the method according to the fifth aspect of the present disclosure may further comprise: determining a set of MGCs and a set of MCCs corresponding to the set of MGCs, according to the information about the relation between the MGC and the MCC. In an embodiment, the set of the MGCs is to be configured to the terminal device for performing one or more procedures in the second network, and the set of the MCCs is to be configured to the terminal device for performing one or more multi-carrier operations in the first network.

In accordance with an exemplary embodiment, the determination of the set of the MGCs and the set of the MCCs may be based at least in part on one or more of: an amount of data in a buffer for the terminal device; expected data rate and/or throughput of the terminal device; and processing resources of the network node.

In accordance with an exemplary embodiment, the method according to the fifth aspect of the present disclosure may further comprise: transmitting MGC information to the terminal device to configure the terminal device with the set of the MGCs.

In accordance with an exemplary embodiment, the method according to the fifth aspect of the present disclosure may further comprise: transmitting MCC information to the terminal device to configure the terminal device with the set of the MCCs.

In accordance with an exemplary embodiment, the configuration of the set of the MCCs and/or the configuration of the set of the MCCs of the terminal device may be valid within a predetermined period of time.

In accordance with an exemplary embodiment, the method according to the fifth aspect of the present disclosure may further comprise: receiving, from the terminal device, a request for configuring the terminal device with one or more MGPs for one or more procedures in the second network.

In accordance with an exemplary embodiment, the network node may support multi-USIM operation of the terminal device.

According to a sixth aspect of the present disclosure, there is provided an apparatus which may be implemented as a network node. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a network node. The apparatus may comprise an obtaining unit and a performing unit. In accordance with some exemplary embodiments, the obtaining unit may be operable to carry out at least the obtaining step of the method according to the fifth aspect of the present disclosure. The performing unit may be operable to carry out at least the performing step of the method according to the fifth aspect of the present disclosure.

According to various exemplary embodiments, a terminal device capable of multi-SIM operation may be configured with a proper number of CCs in a first network and a corresponding number of MGPs in a second network, by using a relation or mapping between a MGC for the second network and a MCC for the first network. This can improve network performance and enhance resource utilization while meeting different service requirements.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary DRX cycle according to some embodiments of the present disclosure;

FIGS. 2A-2C are diagrams illustrating examples of gap pattern according to some embodiments of the present disclosure;

FIG. 3 is a diagram illustrating an exemplary multi-USIM scenario according to an embodiment of the present disclosure;

FIGS. 4A-4B are flowcharts illustrating various methods according to some embodiments of the present disclosure;

FIG. 5 is a block diagram illustrating an apparatus according to an embodiment of the present disclosure;

FIGS. 6A-6B are block diagrams illustrating various apparatuses according to some embodiments of the present disclosure;

FIG. 7 shows an example of a communication system 700 in accordance with some embodiments;

FIG. 8 is a block diagram of a host 800, which may be an embodiment of the host 716 of FIG. 7, in accordance with various aspects described herein; and

FIG. 9 shows a communication diagram of a host 902 communicating via a network node 904 with a UE 906 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future. The term “node” used herein may refer to a network node or a terminal device (e.g., user equipment (UE), etc.).

Examples of network nodes are base station (BS), NodeB, multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), central unit (e.g. in a gNB), distributed unit (e.g. in a gNB), baseband unit, centralized baseband, centralized radio access network (C-RAN), access point (AP), transmission points, transmission nodes, transmission reception point (TRP), remote radio unit (RRU), remote radio header (RH), nodes in distributed antenna system (DAS), core network node (e.g., mobile switching center (MSC), mobility management entity (MME), etc.), operation and maintenance (O&M), operation support system (OSS), self-organizing network (SON), positioning node (e.g., evolved serving mobile location center (E-SMLC)), etc.

More generally, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a UE, or other suitable devices. The non-limiting term UE refers to any type of wireless device communicating with a network node and/or with another UE in a cellular or mobile communication system. Examples of UE are target device, device to device (D2D) UE, vehicle to vehicle (V2V) UE, machine type UE, machine-type communication (MTC) UE or UE capable of machine to machine (M2M) communication, personal digital assistant (PDA), tablet, mobile station (MS), access terminal (AT), mobile terminal, subscriber station, smart phone, laptop embedded equipment (LEE), laptop mounted equipment (LME), universal serial bus (USB) dongles, etc.

The terminal device may include, but not limited to, portable computers, image capture terminal devices such as digital cameras, gaming terminal devices, music storage and playback appliances, a mobile phone, a cellular phone, a wearable device, a vehicle, and the like.

As yet another specific example, in an Internet of things (IOT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a M2M device, which may in the 3GPP context be referred to as MTC device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

The term radio access technology (RAT) may refer to any RAT e.g. universal terrestrial radio access (UTRA), evolved-UTRA (E-UTRA), NB-IoT, WiFi, Bluetooth, next generation RAT, new radio (NR), 4G, 5G, etc. Any of the equipment denoted by the term node, network node or radio network node may be capable of supporting a single or multiple RATs.

The term signal or radio signal used herein can be any physical signal or physical channel. Examples of downlink (DL) physical signals are reference signal (RS) such as primary synchronization signal (PSS), secondary synchronization signal (SSS), channel state information-reference signal (CSI-RS), demodulation reference signal (DMRS) signals in synchronization signal and physical broadcast channel block (which is also known as SS/PBCH block or SSB for short), discovery reference signal (DRS), common reference signal (CRS), positioning reference signal (PRS), etc. The RS may be periodic, e.g. RS occasion carrying one or more RSs may occur with certain periodicity e.g. 20 ms, 40 ms, etc. The RS may also be aperiodic. Each SSB may carry NR-PSS, NR-SSS and NR-PBCH in 4 successive symbols. One or multiple SSBs may be transmitted in one SSB burst which is repeated with certain periodicity e.g. 5 ms, 10 ms, 20 ms, 40 ms, 80 ms and 160 ms. The UE may be configured with information about SSB on cells of certain carrier frequency by one or more SS/PBCH block measurement timing configuration (SMTC) configurations. The SMTC configuration may comprise parameters such as SMTC periodicity, SMTC occasion length in time or duration, SMTC time offset with regard to reference time (e.g. serving cell's system frame number (SFN)), etc. Therefore, SMTC occasion may also occur with certain periodicity e.g. 5 ms, 10 ms, 20 ms, 40 ms, 80 ms and 160 ms. Examples of uplink (UL) physical signals are reference signal such as sounding reference signal (SRS), DMRS, etc. The term physical channel refers to any channel carrying higher layer information e.g. data, control, etc. Examples of physical channels are physical broadcast channel (PBCH), narrowband physical broadcast channel (NPBCH), physical downlink control channel (PDCCH), physical downlink shared channel (PDSCH), physical uplink control channel (PUCCH), physical uplink shared channel (PUSCH), SPDSCH, SPUCCH, sPUSCH, MPDCCH, NPDCCH, NPDSCH, E-PDCCH, NPUSCH, etc.

The term time resource used herein may correspond to any type of physical resource or radio resource expressed in terms of length of time. Examples of time resources are: symbol, time slot, subframe, radio frame, transmission time interval (TTI), interleaving time, slot, sub-slot, mini-slot, SFN cycle, hyper-SFN (H-SFN) cycle, etc.

The term multi-USIM used herein may also be called as multi-subscription, multi-SIM or dual SIM or dual-USIM, etc. The term USIM may also be simply called as SIM. Therefore, the terms USIM and SIM may be used interchangeably in this document. Each USIM (or SIM) in the UE may be associated with at least subscription of a mobile network operator (MNO).

The term measurement gap configuration (MGC) used herein may refer to one or more measurement gap patterns (MGPs), which are configured or can be configured for a UE for one or more purposes or procedures or operations, e.g. performing measurements, monitoring and/or receiving paging, monitoring and/or receiving system information (SI), monitoring and/or receiving short messages, operating (transmitting and/or receiving) random access (RA) related signals (e.g. preamble, RA response message, etc.), etc. MGPs may be any type of gap pattern, e.g., legacy MGP, Pre-MGP, network control small gap (NCSG), etc. One or more MGPs may be periodic, aperiodic or semi-persistent. The MGC may also be called as MUSIM MGC (MMGC) as they are used in the MUSIM scenario. The MGP may also be called as MUSIM MGP (MMGP).

The term multi-carrier (MC) configuration (MCC) used herein may refer to a configuration of two or more component carriers (CCs), which may enable a UE to operate on or served by at least 2 cells on their respective CCs. Examples of MC operations are carrier aggregation (CA), dual connectivity (DC), multi-connectivity (MuC), etc. A special case of MCC may comprise of single CC, e.g., to operate on or served by one CC. This special case may also be interchangeably called as a single carrier configuration, baseline MC configuration, basic MC configuration or reference MC configuration.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

A multi-USIM UE may have two or more subscriptions for different services (e.g., use one individual subscription and one family circle plan). Each USIM or SIM may be associated with one subscription. Different USIMs or SIMs in the UE may be associated with or belong to or registered with the same operator or different operators. In a MUSIM scenario, the UE may be in radio resource control (RRC) idle or inactive with regard to all the registered networks. In this case, the UE may need to monitor and receive paging from more than one network. In another MUSIM scenario, the UE may be in RRC idle or inactive with regard to one of the registered networks while in RRC connected with regard to another network. In this case, the UE may need to monitor and receive paging from one network while receiving/transmitting data in another network.

In 3GPP Release 17 (Rel-17), the focus is standardizing multi-USIM for UEs having a single transmitter (1TX) and a single receiver (1RX), or a single transmitter and dual receivers (2RX). This means that the UE may not be able to communicate in two networks at the same time. MUSIM gaps, similar to the measurement gaps, are therefore defined which may enable the UE to be connected to one network but (temporarily) switch to the other network, e.g., to monitor paging or to perform measurements in that network. The 3GPP specification defines both periodic and aperiodic MUSIM gaps.

Multicarrier (MC) operation is a concept where a UE can operate using multiple carriers (sometimes referred to as cells) that the network has available. With a greater number of carriers, more spectrum can be used by the UE and hence higher throughput can be achieved. Examples of MC operations are carrier aggregation (CA), dual connectivity (DC), multi-connectivity (MuC), etc. The carrier frequency is also called as component carrier (CC), frequency layer, serving carrier, frequency channel, etc.

A UE may be configured with one or more serving cells. Examples of serving cells are special cell (SpCell), secondary cell (SCell), etc. Examples of SpCell are primary cell (PCell), primary secondary cell (PSCell), etc. The carrier frequencies of SpCell, SCell, PCell and PSCell are called as special CC (SpCC) or simply SpC, secondary CC (SCC), primary CC (PCC) and primary secondary CC (PSCC) or simply PSC, respectively.

In CA, a UE may have one primary serving cell (called PCell) and one or more secondary serving cells (SCells). The PCell is considered more important and for example some control signaling is handled via the PCell.

MuC may comprise of two or more cell groups (CGs). DC, which is special case of MuC, may comprise of 2 CGs: a master cell group (MCG) which contains at least a PCell, and a secondary cell group (SCG). Each of MCG and SCG may further contain one or more SCells. The PCell may manage (e.g., configure, change, release, etc.) all SCells in MCG and PSCell in SCG. PSCell may manage all SCells in SCG. The cells in MCG and SCG may belong to the same RAT (e.g., all cells are NR in both MCG and SCG like in NR-DC) or they may belong to different RATs (e.g., LTE cells in MCG and NR cells in SCG like in EN-DC or NR cells in MCG and LTE cells in SCG like in NE-DC).

In addition, the concept of “configuration” of cells, the concept of “activation” has been introduced for SCells or PSCell (not for the PCell). Cells may be configured (or de-configured) using RRC signaling, which can be slow, and PSCell and SCells can be activated (or deactivated) using a medium access control (MAC) control element, which is faster.

The CCs in MC configuration may belong to the same frequency band (e.g., intra-band MC), or they may belong to different frequency bands (e.g., inter-band MC), or combination thereof (e.g., some CCs are in the same frequency band while other CCs are in different frequency bands), etc. The CCs may also belong to the same frequency range (FR) (e.g., all in FR1 or all in FR2), or they may belong to different FRs (e.g., some CCs in FR1 while others in FR2).

A UE may perform measurements on one or more DL and/or UL reference signals (RSs) of one or more cells in different UE activity states, e.g., RRC idle state, RRC inactive state, RRC connected state, etc. The measured cell may belong to or operate on the same carrier frequency as of the serving cell (e.g., intra-frequency carrier) or it may belong to or operate on different carrier frequency as of the serving cell (e.g., non-serving carrier frequency). Examples of RS are discovery signal or discovery reference signal (DRS), CSI-RS, CRS, DMRS, SRS, signals in SS/PBCH block (SSB), PSS, SSS, etc. Each SSB may carry NR-PSS, NR-SSS and NR-PBCH in 4 successive symbols. One or multiple SSBs may be transmitted in one SSB burst which is repeated with certain periodicity, e.g., 5 ms, 10 ms, 20 ms, 40 ms, 80 ms and 160 ms. The UE may be configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN), etc. Therefore, SMTC occasion may also occur with certain periodicity, e.g., 5 ms, 10 ms, 20 ms, 40 ms, 80 ms and 160 ms.

A measurement may also be called radio resource management (RRM) measurement. The measurement may be used for one or more procedures, e.g., mobility, positioning, self-organizing network (SON), minimization of drive test (MDT), etc. Examples of measurements are cell identification (e.g., PCI acquisition, cell detection), reference symbol received power (RSRP), reference symbol received quality (RSRQ), secondary synchronization RSRP (SS-RSRP), SS-RSRQ, SINR, RS-SINR, SS-SINR, CSI-RSRP, CSI-RSRQ, acquisition of system information (SI), cell global ID (CGI) acquisition, reference signal time difference (RSTD), UE RX-TX time difference measurement, radio link quality, radio link monitoring (RLM), which consists of out of synchronization (out of sync) detection and in-synchronization (in-sync) detection, Layer-1 RSRP (L1-RSRP), Layer-1 SINR (L1-SINR), etc.

In RRC_IDLE, a UE may monitor the paging channels for core network-initiated paging. In RRC_INACTIVE, the UE may also monitor paging channels for RAN-initiated paging. In RRC_INACTIVE, the UE can move within an area configured by NG-RAN (the RAN without notifying NG-RAN). The UE in RRC_IDLE or RRC_INACTIVE typically monitors paging channels during one paging occasion (PO) per DRX cycle in the serving cell. This is called as the paging DRX cycle, which is configured by the network. The RRC_INACTIVE UE however may look for its RAN identity in the RRC_IDLE DRX occasions (overlapping with RRC_INACTIVE DRX occasions) in case the network pages the UE. The different POs in a DRX cycle may be configurable via system information and the network may distribute UEs to the POs based on their identifiers (IDs). A PO may be a set of DL control channel (e.g., PDCCH) monitoring occasions and may consist of one or more time resources (e.g., time slots, subframes, etc.). The UE may further monitor and receive system information (SI) of a cell. The paging occasions in the two states (RRRC IDLE/INACTIVE state) may be multiples of each other; e.g., the RRC_INACTIVE DRX cycles might be 1.28 seconds while RRC_IDLE state DRX occasions are once per 2.56 seconds; however, in this case they coincide every second occasion. Examples of SI are master information block (MIB), one or more system information block (SIB), etc. MIB and SIB are mapped or transmitted on physical channels such as PBCH and PDSCH, respectively. The UE may further monitor and receive short messages.

In RRC_IDLE and RRC_INACTIVE, the UE can perform serving cell evaluation, cell selection, and cell reselection including detection and measurements. In RRC_IDLE or RRC_INACTIVE, the UE may measure the serving cell (e.g. SS-RSRP and SS-RSRQ level of the serving cell) and based on the serving cell measurement evaluate the cell selection criterion S, e.g., as defined in 3GPP technical specification (TS) 38.304 v16.6.0 for the serving cell at least once every M1*N1 DRX cycle; where N1 is the scaling factor given in Table 1 and:
M1=2 if SMTC periodicity (T_{SMTC})>20 ms and DRX cycle≤0.64 second;
otherwise M1=1.

TABLE 1
Evaluation of serving cell during Nₛₑᵣᵥ

| DRX cycle | Scaling Factor (N1) | | Nₛₑᵣᵥ [number of |
|---|---|---|---|
| length [s] | FR1 | FR2^{Note 1} | DRX cycles] |
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note 1}:
Applies for UE supporting power class 2&3&4. For UE supporting power class 1 or 5, N1 = 8 for all DRX cycle length.

The UE may filter each of the serving cell measurements (e.g., SS-RSRP and SS-RSRQ measurements of the serving cell) using at least 2 measurements. Within the set of measurements used for the filtering, at least two measurements may be spaced by, at least DRX cycle/2. If the UE has evaluated according to Table 1, that in Nserv consecutive DRX cycles the serving cell does not fulfil the cell selection criterion S defined in 3GPP TS 38.304 v17.1.0, then the UE may need to initiate the measurements of all neighbor cells indicated by the serving cell, regardless of the measurement rules currently limiting UE measurement activities.

Another example of requirements for different NR intra-frequency measurements (e.g., NR cell identification, SS-RSRP, SS-RSRQ, etc.) performed by the UE in RRC_IDLE and RRC_INACTIVE is shown in Table 2.

TABLE 2
Intra-frequency cell reselection requirements in NR:
T_{detect, NR}_{_{—}}_{Intra}, T_{measure, NR}_{_{—}}_{Intra} and T_{evaluate, NR}_{_{—}}_{Intra}

| | | | T_{detect, NR}_{_{—}}_{Intra} [s] | T_{measure, NR}_{_{—}}_{Intra} [s] | T_{evaluate, NR}_{_{—}}_{Intra} |
|---|---|---|---|---|---|
| DRX cycle | Scaling Factor (N1) | | (number of DRX | (number of DRX | [s] (number of DRX |
| length [s] | FR1 | FR2^{Note 1} | cycles) | cycles) | cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 (28 × N1) | 1.28 × N1 (2 × N1) | 5.12 × N1 (8 × N1) |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

^{Note 1}:
Applies for UE supporting power class 2&3&4. For UE supporting power class 1 or 5, N1 = 8 for all DRX cycle length.
Note 2:
M2 = 1.5 if SMTC periodicity of measured intra-frequency cell > 20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

The UE may identify new intra-frequency cells and perform SS-RSRP and SS-RSRQ measurements of the identified intra-frequency cells within T_{detect,NR_intra}. The UE may measure SS-RSRP and SS-RSRQ of the identified intra-frequency cells at least every T_{measure,NR_Intra}. The UE may evaluate an identified cell for cell reselection within T_{evaluate,NR_Intra}. The UE may filter SS-RSRP and SS-RSRQ measurements of each measured intra-frequency cell using at least 2 measurements. Within the set of measurements used for the filtering, at least two measurements may be spaced by at least T_{measure,NR_Intra}/2.

The UE may not consider a NR neighbor cell in cell reselection if it is indicated as not allowed in the measurement control system information of the serving cell.

Similar requirements may be specified for NR inter-frequency measurements (e.g., cell identification, SS-RSRP, SS-RSRQ, etc.) and inter-RAT measurements (e.g., LTE cell identification, LTE RSRP, LTE RSRQ, etc.) performed by the UE in RRC_IDLE and RRC_INACTIVE.

The UE may be configured with a DRX cycle to use in all RRC states (e.g., RRC idle state, RRC inactive state and RRC connected state) to save UE power consumption and battery life. Examples of lengths of DRX cycles currently used in RRC idle/inactive state are 256 ms, 320 ms, 640 ms, 1.28 s, 2.56 s, 5.12 s, 10.24 s, etc. Examples of lengths of DRX cycles currently used in RRC connected state may range from 256 ms to 10.24 s. The DRX cycle may be configured by a network node and may be characterized by the following parameters:
On duration: During the on duration of the DRX cycle, a timer called ‘onDurationTimer’, which may be configured by the network node, is running. This timer specifies the number of consecutive control channel subframes (e.g., PDCCH slots) at the beginning of a DRX Cycle. It is also interchangeably called as DRX ON period. It is the duration (e.g., in number of DL subframes) during which the UE after waking up from DRX may receive control channel (e.g., PDCCH, wake up signal, etc.). If the UE successfully decodes the control channel (e.g., PDCCH) during the on duration, then the UE may start a drx-inactivity timer and stay awake until its expiry.
drx-inactivity timer: It specifies the number of consecutive control channel (e.g., PDCCH,) subframe(s) after the subframe in which a control channel (e.g., PDCCH) indicates an initial UL or DL user data transmission for this MAC entity. It is also configured by the network node.
DRX active time: This time is the duration during which the UE monitors the control channel (e.g., PDCCH, wake up signals, etc.). In other words, this is the total duration during which the UE is awake. This includes the “on-duration” of the DRX cycle, the time during which the UE is performing continuous reception while the inactivity timer has not expired and the time the UE is performing continuous reception while waiting for a DL retransmission after one hybrid automatic repeat request (HARQ) round trip time. This means duration over which the drx-inactivity timer is running is called as DRX active time i.e., no DRX is used by the UE.
DRX inactive time: The time during the DRX cycle other than the active time is called as DRX inactive time, i.e., DRX is used by the UE.

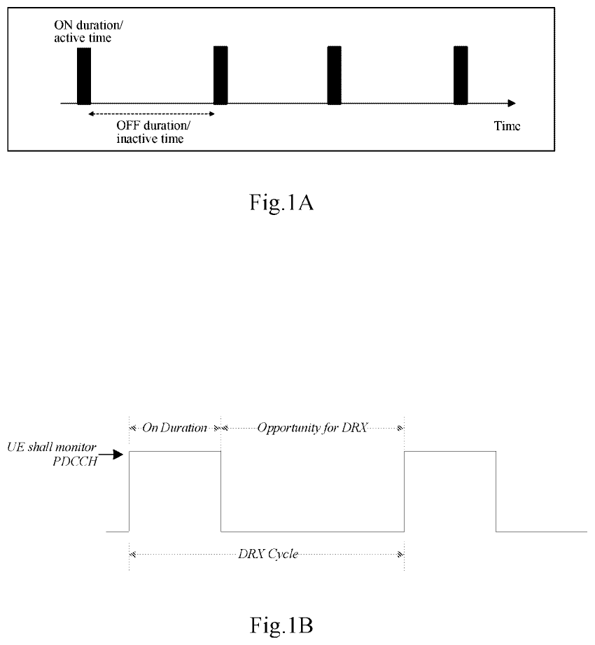

FIGS. 1A-1B are diagrams illustrating exemplary DRX cycle according to some embodiments of the present disclosure. As shown in FIG. 1A, the DRX active time and DRX inactive time are also called as DRX ON and DRX OFF durations of the DRX cycle, respectively. The DRX inactive time may also be called as non-DRX or non-DRX period. The DRX cycle operation with different DRX related parameters is illustrated in FIG. 1B.

The DRX configuration herein may also be an enhanced or extended DRX (eDRX) configuration which applies in RRC_IDLE or RRC_INACTIVE states (only up to 10.24 seconds). In legacy DRX related procedures, the UE can be configured with DRX cycle length of up to 10.24 seconds. But UEs supporting extended DRX (eDRX) can be configured with a DRX cycle at least longer than 10.24 seconds and typically much longer than 10.24 seconds, i.e., in order of several seconds to several minutes, e.g., 176 minutes. The eDRX configuration parameters may include an eDRX cycle length, paging window length also known as paging time window (PTW) length, etc. Within a PTW of the eDRX, the UE may be further configured with one or more legacy DRX cycles.

Measurement gap pattern (MGP) may be used by a UE for performing measurements on cells of the non-serving carriers (e.g., inter-frequency carrier, inter-RAT carriers, etc.). In NR, gaps may also be used for measurements on cells of the serving carrier in some scenarios, e.g., if the measured signals (e.g., SSB) are outside the bandwidth part (BWP) of the serving cell. The UE may be scheduled in the serving cell only within the BWP. During the gap, the UE may not be scheduled for receiving/transmitting signals in the serving cell. A measurement gap pattern may be characterized or defined by several parameters, e.g., measurement gap length (MGL), measurement gap repetition period (MGRP), measurement gap time offset (MGTO) with regard to reference time (e.g., slot offset with regard to serving cell's system frame number (SFN), such as SFN=0), measurement gap timing advance (MGTA), etc.

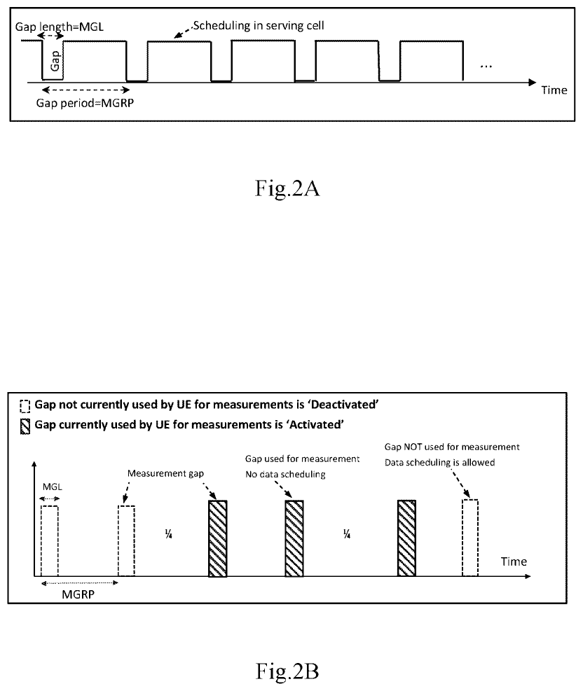

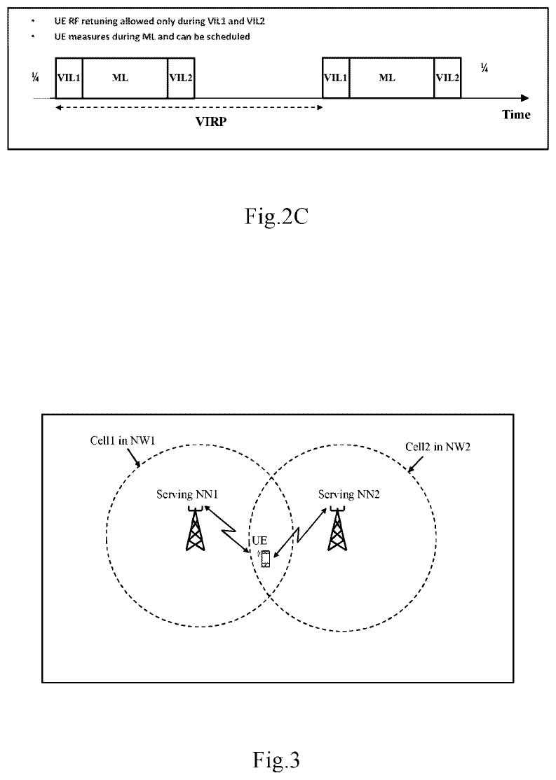

FIGS. 2A-2C are diagrams illustrating examples of gap pattern according to some embodiments of the present disclosure. An example of MGP in NR is shown in FIG. 2A. As an example, MGL may be 1.5, 3, 3.5, 4, 5.5 or 6 ms, and MGRP may be 20, 40, 80 or 160 ms. Such type of MGP may be configured by a network node and may also be called as network controlled or network configurable MGP. Therefore, the serving base station may be fully aware of the timing of each gap within the MGP.

In NR, there may be two major categories of MGPs: per-UE measurement gap patterns and per-FR measurement gap patterns. In NR, the spectrum is divided into two frequency ranges namely FR1 and FR2. FR1 is currently defined from 410 MHz to 7125 MHz. FR2 range is currently defined from 24250 MHz to 52600 MHz. In another example, FR2 range can be from 24250 MHz to 71000 MHz, where the frequency range 24250-52600 MHz is called FR2-1 and frequency range 52600-71000 MHz is called FR2-2. The FR2 range is also interchangeably called as millimeter wave (mmwave) and corresponding bands in FR2 are called as mmwave bands. In future, more frequency ranges may be specified, e.g., FR3. An example of FR3 is frequency ranging between 7125 MHz and 24250 MHz.

When configured with per-UE MGP, the UE may create gaps on all the serving cells (e.g., PCell, PSCell, SCells, etc.) regardless of their frequency range. The per-UE MGP may be used by the UE for performing measurements on cells of any carrier frequency belonging to any RAT (e.g., 5G NR, 4G LTE/LTE-advanced, 3G WCDMA/HSPA/CDMA2000, 2G GSM) or frequency range (FR). When configured with per-FR MGP (if UE supports this capability), the UE may create gaps only on the serving cells of the indicated FR whose carriers are to be measured. For example, if the UE is configured with per-FR1 MGP, then the UE may create measurement gaps only on serving cells (e.g., PCell, PSCell, SCells, etc.) of FR1 while no gaps are created on serving cells on carriers of FR2. The per-FR1 gaps can be used for measurement on cells of only FR1 carriers. Similarly, per-FR2 gaps when configured are only created on FR2 serving cells and can be used for measurement on cells of only FR2 carriers. Support for per FR gaps is a UE capability, i.e., certain UE may only support per UE gaps according to their capability.

Pre-configured measurement gaps (Pre-MG) (or Pre-MG pattern) are also specified in Rel-17. The one or more gaps which are not used for the measurement (e.g., SSB to be measured is within the UE's active BWP) are considered to be ‘deactivated’ or the status of Pre-MG is set to ‘deactivation’. The one or more gaps which are used for the measurement (e.g., SSB to be measured is NOT within the UE's active BWP) are considered to be ‘activated’ or the status of Pre-MG is set to ‘activation’. The UE can be scheduled with data in DL and/or in UL by the base station during the deactivated gaps in the serving cell, i.e., when the status of Pre-MG is deactivated. The UE may not be expected to receive any data from or transmit any data to the base station during the activated gaps in the serving cell, i.e., when the status of Pre-MG is activated. An example of Pre-MG pattern in NR is illustrated in FIG. 2B.

Network control small gap (NCSG) pattern may be used by the UE for measurements, which may not need gaps, e.g., measurement performed on a serving carrier frequency when the serving cell (e.g., SCell, PSCell, etc.) is deactivated, on carrier frequency when UE has spare radio chain, etc. To perform measurement without gap, the UE can retune its receiver anytime causing unpredictable interruptions on one or more serving cells. But with NCSG, the UE may be allowed to retune only during VIL1 and VIL2. This in turn ensures the interruptions occur only during VIL1 and VIL2 enabling the base station to avoid scheduling during VIL1 and VIL2. This may prevent the loss of scheduling grants, UE feedback signaling such as HARQ feedback etc. VIL1 and VIL2 may comprise of only 1 or few slots. However, the UE may measure during the measurement length (ML) of the NCSG pattern and can be scheduled with data unless there is scheduling restriction. ML, VIL1 and VIL2 may occur periodically once every visible interruption repetition period (VIRP). During the VIL1 and VIL2, the UE may not be expected to transmit and receive any data. Where, VIL1 is the visible interruption length before the ML and VIL2 is the visible interruption length after the ML. During ML, whether the UE is expected to transmit and receive data on the corresponding serving carrier(s) may depend on the scheduling restriction requirements, e.g., as specified in 3GPP TS 38.133 v17.6.0. An example of NCSG pattern with the NCSG configuration parameters VIL1, ML, VIL2 and VIRP are illustrated in FIG. 2C.

Concurrent measurement gap pattern (C-MGP) or interchangeably called as concurrent gaps or concurrent measurement gaps are also specified. C-MGP may comprise of multiple measurement gap patterns (e.g., 2 or more MGPs) which can be configured by the network node using the same message or by different messages (e.g., the same or different RRC messages). The C-MGP typically comprises of at least two simultaneous configured measurement gap patterns (e.g., two individual MGP each of the type shown in FIG. 2A, FIG. 2B or FIG. 2C or combination of any two or more types of MGP). The at least two MGPs may be configured using the same or different MGP related parameters. For example, MGL, MGRP, etc. for the at least 2 MGPs may be the same or they may be different. C-MGP comprising of at least two MGPs of different types may also be called as heterogeneous concurrent measurement par pattern (H-CMP) or heterogeneous concurrent measurement gaps.

In a multi-USIM scenario, a UE capable of multi-USIM may be served by at least two serving cells which belong to different networks (NWs). The UE configured to perform one or more procedures in one or more cells of one of the networks (e.g., in NW2) may require gaps for these procedures, e.g., gaps may be created on serving cell(s) in NW1. The UE may typically be configured with multiple gap patterns for different purposes, e.g., for measurements, monitoring paging, acquisition of system information, etc. The gaps in NW1 may last very long especially when used for certain periodic procedures like measurements and paging monitoring e.g. in RRC idle or RRC inactive state. During the gaps, serving cell(s) in NW1 may not be able to schedule the UE with data. This may degrade user throughput and service quality in NW1 especially when the UE is in RRC connected state in NW1.

The 3GPP Release 18 (Rel-18) work item on multi-USIM enhancement may consider UEs with two or more receivers (RX) and/or transmitters (TX). This enables the UE to be connected to two (or more) networks at the same time. The UE may typically support multi-carrier configuration, e.g., CA, dual connectivity. This enhanced UE RX/TX architecture coupled with supported multi-carrier configuration can be exploited to optimize the use of gaps in multi-SIM operation. However, currently there is no such framework or mechanism exists.

Various exemplary embodiments of the present disclosure propose solutions to provide a framework or mechanism enabling a network to tradeoff between number of gap patterns and multi-carrier configuration in multi-USIM operation. Embodiments are described with respect to a UE which may be configured to operate in multi-USIM scenario where: the UE's first serving cell (cell1) and a first network node (NN1) managing or serving cell1 are comprised in a first network (NW1); and the UE's second serving cell (cell2) and a second network node (NN2) managing or serving cell2 are comprised in a second network (NW2).

In accordance with an exemplary embodiment, a UE may obtain a relation or mapping between a MGC for performing one or more procedures/operations in NW2 and a MCC for performing multi-carrier operation(s) in NW1, and transmit information about the obtained relation or mapping to at least NN1. The UE may further transmit the information about the obtained relation or mapping to NN2, e.g., in UE assistance information (UAI) in an RRC message/signaling. The UE may further receive from NN1, information about the MGC for performing the one or more procedures/operations in NW2, and information about the MCC for performing the multi-carrier operation(s) in NW1. The UE may further apply or use: the received information about the MGC for performing the one or more procedures/operations in NW2, and the received information about the MCC for performing the multi-carrier operation(s) in NW1. The UE may obtain the information about the relation or mapping or association between the MGC and the MCC based on one or more mechanisms (e.g., a pre-defined rule, or autonomously determined by the UE, etc.).

In accordance with another exemplary embodiment, NN1 serving a UE, may obtain a relation or mapping between a MGC for the UE to perform one or more operations/procedures in NW2 and a MCC for the UE to perform multi-carrier operation in NW1, and use the obtained information for performing one or more operational tasks. Examples of tasks may comprise: configuring the UE with gap configuration for enabling the UE to perform the one or more operations/procedures in NW2 and/or with MCC for enabling the UE to perform multi-carrier operation in NW1 based on the obtained relation, requesting the UE to perform relax measurements, etc. NN1 may obtain the information about the relation or mapping or association between the MGC and the MCC based on one or more mechanisms (e.g., a pre-defined rule, or by receiving the information about the relation or mapping or association between the MGC and the MCC from the UE, etc.).

In accordance with an exemplary embodiment, the MGC may be expressed or defined in terms of required number of MGPs and/or type of MGPs (e.g., legacy MG, NCSG, Pre-MG or any combination thereof, etc.) for performing the procedures/operations in NW2.

In accordance with another exemplary embodiment, the MCC may be expressed or defined in terms of maximum number of component carriers (CCs) and/or type of supported multicarrier (MC) operation(s) (e.g., CA, DC, intra-band MC, inter-band MC, or any combination thereof, etc.) for performing the MC operation in NW1.

The proposed solutions according to various exemplary embodiments of the present disclosure may allow avoiding or minimizing the number of gap patterns in one network (e.g., NW2) by configuring fewer or no CCs in another network (e.g., NW1) in a multi-SIM operational scenario. Many advantages may be achieved by applying the proposed solutions. For example, the proposed solutions can increase scheduling opportunities by reducing need for gaps in another network, and/or increase user bit rate by minimizing the use of gaps. In addition, the user data rate/bit rate requirements can be met, e.g., by configuring more CCs in NW1 and more MGPs in NW2.

Various embodiments described in the present disclosure may be applicable to a network scenario where a UE served by at least two cells: a first cell (cell1) and a second cell (cell2). Cell1 and cell2 may operate on or belong to or configured using: a first carrier frequency (F1) and a second carrier frequency (F2), respectively. In one example, F1 and F2 are different carrier frequencies (e.g., with different ARFCNs). In another example, F1 and F2 are the same carrier frequencies (e.g., with same ARFCN). The carrier frequency is also called as component carrier (CC), frequency layer, serving carrier, frequency channel, etc. The carrier frequency related information may be signaled to the UE using a channel number, e.g., ARFCN, NR-ARFCN, etc. F1 and F2 may belong to the same or different frequency bands. The coverage areas of cell1 and cell2 may fully overlap or may not overlap at all or may partially with respect to each other.

Cell1 in turn may be served or managed or controlled by a first network node (NN1) which is comprised in a first network (NW1). Cell2 in turned may be served or managed or controlled by a second network node (NN2) which is comprised in a second network (NW2). Therefore, the UE may be served by or managed by the at least two networks (NW1 and NW2). In one example, NW1 and NW2 may be managed by or belong to the same operator. In another example, NW1 and NW2 may be managed by or belong to different operators. This may be realized by the UE capable of multi-USIM operation, e.g., supporting at least 2 USIMs. For example, one of the supported USIM may be associated with subscription to NW1, while the other supported USIM may be associated with subscription to NW2. In an exemplary scenario, the UE may be served by one serving cell in each NW, e.g., by cell1 and cell2 in NW1 and NW2, respectively. In another exemplary scenario, the UE may further be served by more than one cell in NW1 and/or by more than one cell in NW2.

Examples of cells may be serving cell, neighbor cell, non-serving cell, etc. In multicarrier (MC) operation, the UE may be served by more than one serving cells. Each cell may operate or belong to a carrier frequency.

FIG. 3 is a diagram illustrating an exemplary multi-USIM scenario according to an embodiment of the present disclosure. As shown in FIG. 3, a UE capable of multi-USIM operation may be served by two different cells (cell1 and cell2) in the operators' networks, e.g., via two network nodes (NN1 and NN2), respectively. The two different cells (cell1 and cell2) may belong to two different communication networks (NW1 and NW2).

In accordance with an exemplary embodiment, the UE may be served by cell1 and cell2 during at least partially overlapping time period. The UE may also be served by more than one cells in NW1 and/or in NW2, e.g., when the UE is configured with multicarrier (MC) configuration by a network node.

In one example, NN1 and NN2 may be two different logical network nodes as well as two different physical network nodes. In another example, NN1 and NN2 may be two different logical network nodes but may be comprised in the same physical network node. NN1 and NN2 may or may not be physically located at the same site.

In accordance with an exemplary embodiment, the UE may be served by cell1 during time period D1 and by cell2 during time period D2. In one example, D1 and D2 may fully overlap in time, e.g., starting at the same time instance and also ending at the same time instance. In another example, D1 and D2 may only partially overlap in time, e.g., D1 and D2 may start at the same time but end at different time instances, or D1 and D2 may start at different time instances but end at the same time instance, or D1 and D2 may start at different time instances and also end at different time instances.

In one example, the UE may be configured to operate in the same RRC activity state with regard to cell1 and cell2 during at least partially overlapping time. In another example, the UE may be configured to operate in different RRC activity states with regard to cell1 and cell2 during at least partially overlapping time. Examples of RRC activity states may be low activity RRC state, high activity state, etc. In low activity RRC state, the UE may typically be configured to operate using a DRX cycle which is equal to or larger than certain threshold, e.g., 320 ms or longer. In low activity RRC state, the UE may further be configured with extended DRX (eDRX) cycle. In high activity RRC state, the UE may or may not be configured to operate with a DRX cycle or may be configured with any DRX cycle when configured. Examples of low activity RRC state may be RRC idle state, RRC inactive state, etc. An example of high activity RRC state is RRC connected state, etc.

Some exemplary embodiments are described with respect to a scenario where the UE is served by cell1 in NN1 in high activity RRC state (e.g., RRC connected state) but is served by cell2 in NN2 in any of the low activity state and high activity RRC state. Some exemplary embodiments are described with respect to a scenario where the UE is served by cell1 in NN1 in high activity RRC state but is served by cell2 in NN2 in any of the low activity state (e.g., RRC idle state or RRC inactive state).

In accordance with an exemplary embodiment, a method which may be performed by a UE to obtain and transmit a relation between gaps and multi-carrier configurations is provided. In an embodiment, the UE may obtain a relation or mapping or association between a MGC for performing one or more procedures in NW2 and a MCC for performing multi-carrier operation in NW1. In another embodiment, the UE may transmit information about the obtained relation or mapping or association to a network node (e.g., at least NN1).

In accordance with an exemplary embodiment, the UE may further determine that the UE is configured with one or more measurement objects (MOs) on one or more carrier frequencies and/or one or more procedures (e.g., such as SI (e.g., SIB, etc.) reading, monitoring paging, etc.) in a cell (e.g., Cell2) in NW2. The UE may determine this before or after sending the information about the mapping to NN1.

In accordance with an exemplary embodiment, the UE may further request NN1 to configure one or more MGPs for procedures in NW2, e.g., after NN1 has configured or reconfigured the MCCs in NW1 (e.g., based on the MGCs and MCCs relation). The UE may further configure or set up the one or more MGPs and use them for performing the one or more procedures in NW2, e.g., monitoring paging on Cell2, etc.

In accordance with an exemplary embodiment, the UE may transmit the obtained information to the network node using signaling mechanism such as via RRC, medium access control-control element (MAC-CE) or downlink control information (DCI) message/command, etc. The transmitted information may also be part of the UAI (e.g., sent via RRC). The UE may transmit the information about the obtained relation/mapping/association to the network node proactively (e.g., during connection setup, after initial access, etc.) or in response to receiving a request from the network node or whenever one or more conditions or criterions are met (e.g., when buffer size changes by a certain threshold, when there is any change in the mapping, when the UE battery power changes by a certain threshold, etc.). In an embodiment, the information about the relation/mapping/association may comprise an identifier of predefined mapping (e.g., number of MGPs and number of CCs) and/or it may contain detailed information about MGCs (e.g., the UE may indicate a preferred configuration of each MGP for performing one or more procedures in NW2) and/or the detail information about MCCs (e.g., the UE may indicate a preferred configuration to enable or disable the corresponding one or more component carriers). The UE may further indicate the timing information related to the mapping or relation between the MGC and the MCC. For example, the timing information may indicate the time period (Tp) over which the mapping between the MGCs and their corresponding MCCs are applicable or valid. The UE may further indicate or it may be predefined (e.g., in the specification) that during the time outside the indicated time period (Tp), either the UE can operate NW1 and NW2 using default MGC configurations (e.g., up to L1 number of MGPs in NW2) and MCC configurations (e.g., up to L2 number of maximum CCs in NW1) in NW2 and NW1, respectively, or the UE behavior is undefined (e.g., UE operation in NW1 and/or in NW2 is undefined or is not guaranteed or it may operate in best effort manner or it may not be able to meet requirements). In an embodiment, the timing information may comprise one or more of the following timing parameters:
Starting reference time (Ts), e.g., starting time instance when the mapping between MGCs in NW2 and their corresponding MCCs in NW1 are applicable. This may also be a future time, e.g., to allow the UE to complete one or more ongoing tasks such as post processing data received by the UE from a cell in one of the networks (e.g., NW1).
Time period (Tp) over which the mapping between MGCs in NW2 and their corresponding MCCs in NW1 are applicable or valid. Tp starts from Ts.
Ending reference time (Te), e.g., time instance when the mapping between MGCs in NW2 and their corresponding MCCs in NW1 is no more applicable for UE operation in MUSIM scenario. In an example, Te=Tp+Ts.

In accordance with an exemplary embodiment, the parameters, Ts, Tp and Te, may be expressed in terms of absolute time such as UTC time, network time or frame counter (e.g., frame number such as SFN, hyper frame number such as H-SFN, sub-frame number, slot number, combination of SFN or H-SFN and time resource number such as subframe number, etc.) and/or time resource number (e.g., sub-frame number, slot number, symbol number, etc.).

In accordance with an exemplary embodiment, the UE may further use the information about the obtained relation or mapping for one or more additional operational tasks. Examples of such tasks may include:
Transmitting the information about the obtained relation to another network node, e.g., NN2.
In response to, or after transmitting the information about the obtained relation or mapping, the UE may further receive from the network node (e.g., NN1), information about a MGC for performing one or more procedures in NW2.
   The UE may configure or set up one or more MGPs based on the received information about the MGC and further applying or using the configured MGP(s) for performing the one or more procedures in NW2.
   Examples of procedures performed or expected to be performed in NW2 by the UE using the MGC may include: performing measurements on one or more cells, monitoring and/or receiving paging, monitoring and/or receiving system information, monitoring and/or receiving short messages (e.g., SMS, etc.), operating (e.g., transmitting and/or receiving) signals involved in a RA procedure (e.g., transmitting RA preamble, receiving RA response message, etc.).
In response to, or after transmitting the information about the obtained relation or mapping, the UE may further receive from the network node (e.g., NN1), information about the MCC for performing multi-carrier operation in NW1.
   The received MCC may be:
      a new MCC,
      the same as the currently configured MMC (e.g., an indication to maintain currently configured MCC), or
      a modified version of the currently configured MMC (e.g., changing or modifying from the currently configured N number of CCs to M number of CCs). In an example, N>M, and in another example, N<M.
   The UE may configure or set up one or more cells (e.g., PCell, SCell, PSCell, etc.) in NW1 based on the received MCC and further perform a multicarrier operation (e.g., CA, DC, etc. or a single carrier operation if configured MCC is the baseline) using the configured one or more cells in NW1. The term multicarrier operation may refer to the UE receiving and/or transmitting signals (e.g., receiving DL channel such as PDCCH/PDSCH, transmitting UL channel such as PUCCH/PUSCH, etc.) in one or more serving cells.

The principles for obtaining the relation or mapping information and examples of the relation or mapping are described below with examples.

In accordance with an exemplary embodiment, the UE may obtain the information about the mapping or relation between the MGC for performing one or more procedures in NW2 and the MCC for performing multi-carrier operation in NW1 based on one or more of the following mechanisms:
Pre-defined rule or information: In this mechanism, the relation or mapping may be predefined in the specification. In this case, the UE may obtain it by loading or retrieving the relation or mapping from a memory of the UE.
Autonomously determined by the UE: In this mechanism, as an example, the mapping or relation information may be part of the UE capability information. In this case, the mapping may depend on the UE architecture (e.g., number of receive and/or transmit chains) and/or resources (e.g., amount of available memory, processing resources, etc.). In another example, the mapping or relation may be dynamically or semi-statically determined by the UE. In this case, the mapping may depend on one or more of: currently available radio chain(s) in the UE (e.g., available number of receive and/or transmit chains), currently available resources (e.g., amount of available memory, processing resources, etc.), battery power (e.g., used batter power, remaining battery power, etc.), etc.

Various general and specific examples of the mapping or relation or association between a set of MGCs and a set of MCCs are described below.

A general example of the mapping or relation or association between a set of K number of MGCs and a set of K number of MCCs is shown in Table 3. If the mapping is predefined, then the UE may transmit one or more configuration IDs and/or the information containing details of the actual MGC and the MCC associated with that MGC, to a network node, e.g., in UAI. If the mapping is autonomously determined by the UE, then the UE may transmit the information containing the details of the actual MGC and the MCC associated with that MGC, to a network node, e.g., in UAI.

TABLE 3
A general example of mapping or relation
between MGC for NW2 and MCC for NW1

| Configuration | MGC required for | Maximum MCC for MC |
|---|---|---|
| ID | procedures in NW2 | operation in NW1 |
| 1 | MGC #1 (MGC₁) | MCC # 1 (MCC₁) |
| 2 | MGC #2 (MGC₂) | MCC # 2 (MCC₂) |
| 3 | MGC #3 (MGC₃) | MCC # 3 (MCC₃) |
| . . . | . . . | . . . |
| K | MGC # K (MGC_{K}) | MCC # K (MCC_{K}) |

Another general example of the mapping or relation or association between a set of K number of MGCs and a set of K number of MCCs is shown in Table 4. In this example, MGC is expressed in terms of number of MGPs and MCC is expressed in terms of number of CCs and whether the supported MCC is CA and/or DC. In Table 4, Y and N denotes Yes and No, respectively. For example, each configuration ID may comprise of a certain number of MGPs required to perform procedures in NW2 and the maximum number of CCs and type of MC (e.g., CA and/or DC) which the UE can support for performing the MC operation in NW1.

TABLE 4
A general example of mapping or relation
between MGC for NW2 and MCC for NW1

| | | Maximum MCC for MC operation in NW1 | | |
|---|---|---|---|---|
| Configuration | MGC required for | Maximum | Type of MCC | |
| ID | procedures in NW2 | number of CCs | CA | DC |
| 1 | P₁₁ number of MGPs | Q₁₁ | Y/N | Y/N |
| 2 | P₁₂ number of MGPs | Q₁₂ | Y/N | Y/N |
| 3 | P₁₃ number of MGPs | Q₁₃ | Y/N | Y/N |
| . . . | . . . | . . . | . . . | .. . |
| K | P_{1K} number of MGPs | Q_{1K} | Y/N | Y/N |

Another general example of the mapping or relation or association between a set of K number of MGCs and a set of K number of MCCs is shown in Table 5. This example is similar to the previous one in Table 4, except that in Table 5, each MCC also specifies the maximum number of supported bands which can be used by the UE for performing the MC operation.

TABLE 5
A general example of mapping or relation
between MGC for NW2 and MCC for NW1

| | | Maximum MCC for MC operation in NW1 | | | |
|---|---|---|---|---|---|
| | | Maximum | Maximum | | |
| Configuration | MGC required for | number of | number of | Type of MCC | |
| ID | procedures in NW2 | CCs | bands | CA | DC |
| 1 | P₂₁ number of MGPs | Q₂₁ | R1 | Y/N | Y/N |
| 2 | P₂₂ number of MGPs | Q₂₂ | R2 | Y/N | Y/N |
| 3 | P₂₃ number of MGPs | Q₂₃ | R3 | Y/N | Y/N |
| . . . | . . . | . . . | . . . | . . . | . . . |
| K | P_{2K} number of MGPs | Q_{2K} | R_{K} | Y/N | Y/N |

Another general example of the mapping or relation or association between a set of K number of MGCs and the detail MCCs' status for each target CC is shown in Table 6. This example is similar to the previous one in Table 3, except that in Table 6, each target CC's status is suggested by the UE associated to the number of MGC with the status of CC combinations. Furthermore, the UE may also indicate whether support type of MCC with CA/DC similar as shown in Table 5. Alternatively or additionally, the detail MCCs' status may be the detail supported bands' status. The UE may suggest each supported band's status.

TABLE 6
A general example of mapping or relation
between MGC for NW2 and MCC for NW1

| | MGC required | CC | CC | CC | | CC |
|---|---|---|---|---|---|---|
| Configuration | for procedures | Index #0 | Index #1 | Index #2 | | Index #K |
| ID | in NW2 | (Band N1) | (Band N2) | (Band N3) | . . . | (Band NK) |
| 1 | MGC #1 | enable | enable | enable | . . . | disable |
| | (MGC₁) | | | | | |
| 2 | MGC #2 | enable | enable | disable | . . . | disable |
| | (MGC₂) | | | | | |
| . . . | . . . | . . . | . . . | . . . | . . . | . . . |
| K | MGC #K | enable | disable | disable | . . . | disable |
| | (MGC_{K}) | | | | | |

A specific example of the mapping or relation or association between a set of 5 MGCs and a set of 5 MCCs is shown in Table 7. In this example, the UE can support MC with a maximum number of 8 CCs in NW1. The UE may need up to 4 MGPs for performing the procedures in NW2. However, depending on the number of CCs configured in NW1, the UE can adapt the required number of MGPs in NW2. In general, with larger number of CCs used in NW1, the number of MGPs required in NW2 are also increased. For example, to support MC operation with up to 8 CCs in NW1, the UE may need up to 4 MGPs to perform all necessary operations (e.g., measurements, RA, SI, paging reception, etc.) in NW2. On the other hand, if single carrier operation is used in NW1, then the UE can perform all the procedures in NW2 without any MGP.

TABLE 7
A specific example of mapping or relation
between MGC for NW2 and MCC for NW1

| | Number of MGPs | Maximum number of |
|---|---|---|
| Configuration | required for | CCs supported for |
| ID | procedures in NW2 | MC operation in NW1 |
| 1 | 4 | 8 |
| 2 | 3 | 6 |
| 3 | 2 | 4 |
| 4 | 1 | 2 |
| 5 | 0 | 1 |

Another specific example of the mapping or relation or association between a set of 5 MGCs and a set of 8 MCCs is shown in Table 8. The set of 5 MGCs comprises of 0 MGP (no MGP), 1 MGP, 2 MGPs, 3 MGPs and 4 MGPs. Each of the set of 8 MCCs corresponds to a unique configuration ID. For example, configuration ID #5 indicates that the UE can be configured with only 1 CC in NW1 if the UE is not provided with any MGP for performing procedures in NW2. In this example, in addition to the maximum number of CCs, the MCC further indicates the type(s) of the supported MC operation (e.g., CA, DC or both) in NW1. As shown in Table 8, the UE can support larger number of CCs for CA compared to the supported number of CCs for DC for the same MGC. This is because the DC involves more complexity and/or may need more radio chains in the UE compared to the CA. In case of DC, the UE may or may not support CA within the same CG.

TABLE 8
A specific example of mapping or relation
between MGC for NW2 and MCC for NW1

| | | Maximum MCC for | | |
|---|---|---|---|---|
| | | MC operation in NW1 | | |
| | MGC required | Maximum | | |
| Configuration | for procedures | number | Type of MCC | |
| ID | in NW2 | of CCs | CA | DC |
| 1 | 4 | 8 | Y | N |
| 2 | 4 | 4 | Y | Y |
| 3 | 3 | 6 | Y | N |
| 4 | 3 | 3 | Y | Y |
| 5 | 2 | 4 | Y | N |
| 6 | 2 | 2 | N | Y |
| 7 | 1 | 2 | Y | Y |
| 8 | 0 | 1 | N | N |

Another specific example of the mapping or relation or association between a set of 5 MGCs and a set of 8 MCCs is shown in Table 9. The set of 5 MGCs comprises of 0 MGP (no MGP), 1 MGP, 2 MGPs, 3 MGPs and 4 MGPs. Each of the set of 8 MCCs corresponds to a unique configuration ID. In this example, in addition to the maximum number of CCs and the type(s) of MC operation, the MCC further indicates or comprises of maximum number bands for performing the MC operation in NW1. As shown in Table 9, the UE can support larger number of bands for CA compared to the supported number of bands for DC for the same MGC.

TABLE 9
A specific example of mapping or relation
between MGC for NW2 and MCC for NW1

| | | Maximum MCC for | | | |
|---|---|---|---|---|---|
| | | MC operation in NW1 | | | |
| | MGC required | Maximum | Maximum | | |
| Configuration | for procedures | number | number of | Type of MCC | |
| ID | in NW2 | of CCs | bands | CA | DC |
| 1 | 4 | 8 | 4 | Y | N |
| 2 | 4 | 4 | 2 | Y | Y |
| 3 | 3 | 6 | 3 | Y | N |
| 4 | 3 | 3 | 2 | Y | Y |
| 5 | 2 | 4 | 2 | Y | N |
| 6 | 2 | 2 | 1 | N | Y |
| 7 | 1 | 2 | 1 | Y | Y |
| 8 | 0 | 1 | 1 | N | N |

Another specific example of the mapping or relation or association between a set of 4 MGCs and a set of 7 MCCs is shown in Table 10. The set of 4 MGCs comprises of 0 MGP (no MGP), 1 MGP, 2 MGPs and 4 MGPs. Each of the set of 7 MCCs corresponds to a unique configuration ID. Within each MCC, a bit map may be used to indicate which one of the CCs may need to be enabled or disabled in NW1 for configuring a certain number of MGPs in NW2. In this example, the MCC indicates the status of each carrier. The UE may also indicate the number of MGCs associated with the CA/DC configuration. Alternatively or additionally, the MCCs can be the supported bands by the UE.

TABLE 10
A specific example of mapping or relation between MGC for NW2 and MCC for NW1

| | MGC required | CC | CC | CC | | CC | Type of |
|---|---|---|---|---|---|---|---|
| Configuration | for procedures | Index #0 | Index #1 | Index #2 | | Index #7 | MCC |
| ID | in NW2 | (Band N1) | (Band N2) | (Band N3) | . . . | (Band N7) | (CA/DC) |
| 1 | 4 | enable | enable | enable | . . . | enable | CA |
| 2 | 2 | enable | enable | enable | . . . | disable | CA |
| 3 | 1 | enable | enable | disable | . . . | disable | CA |
| 4 | 0 | enable | enable | disable | . . . | disable | CA |
| 5 | 4 | enable | enable | enable | . . . | enable | DC |
| 6 | 2 | enable | enable | enable | . . . | disable | DC |
| 7 | 1 | enable | enable | disable | . . . | disable | DC |

In another example, the UE may include the configuration details of the MUSIM MGCs, when providing the mapping or relation or association between a set of K number of MGCs and a set of K number of MCCs (supported bands). This may be applicable to all the previous examples described above, and extend them by including the information on MGC configuration. In an embodiment, the UE may explicitly provide the configuration values (e.g., gap type (periodic or aperiodic), gap length, gap starting point and gap periodicity) per each required MGC, to a network node. In another embodiment, the configuration per each required MGC may be implicitly provided, by sending the MUSIM Gap Pattern ID value, e.g., MUSIM Gap Pattern IDs as specified in 3GPP TS 38.133 v17.7.0 in Table 9.1.10-1. An example containing MUSIM gap patterns identified by their respective measurement gap pattern IDs is shown in Table 11.

TABLE 11
An example of MGC for MUSIM gap patterns
identified by their gap pattern IDs

| | MUSIM Gap | MUSIM Gap |
|---|---|---|
| MUSIM Gap | Length | Repetition Period |
| Pattern Id | (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 10 | 80 |
| 13 | 20 | 160 |
| 14 | 6 | 320 |
| 15 | 6 | 640 |
| 16 | 6 | 1280 |
| 17 | 6 | 2560 |
| 18 | 10 | 320 |
| 19 | 10 | 640 |
| 20 | 10 | 1280 |
| 21 | 10 | 2560 |
| 22 | 20 | 320 |
| 23 | 20 | 640 |
| 24 | 20 | 1280 |
| 25 | 20 | 2560 |
| 26 | 20 | 5120 |
| 27 | 10 | NA |
| 28 | 20 | NA |

Note 1:
Measurement gap pattern #27, #28 are the aperiodic gap pattern without MGRP.

In another example, the mapping or relation between MGC for NW2 and MCC for NW1 may further depend on the DRX cycle configuration with which the UE is configured or expected to operate in NW2. For example, one of more configuration parameters (e.g., MGRP, MGL, MGP ID, etc.) within the MGC for the same MCC may depend on the length of the DRX cycle configured for UE operation in NW2.

In another example, the mapping or relation between MGC for NW2 and MCC for NW1 may further depend on the type of the low activity RRC state with which the UE is configured or expected to operate in NW2. For example, the number of MGPs within the MGC for the same MCC may depend on whether the UE is in RRC idle state or in in RRC inactive state. In RRC inactive, the UE may be configured with more operations than in RRC idle state. For example, the UE may be required to perform small data transmission in addition to paging monitoring and measurements. Therefore, in an example, the UE may request larger number of MGPs within the MGC for the same MCC when the UE is in RRC inactive state compared to the case when the UE is in RRC idle state. In another example, the UE may request larger number of MGPs within the MGC for the same MCC when the UE is in RRC idle state compared to the case when the UE is in RRC inactive state.

In another example, the mapping or relation between MGC for NW2 and MCC for NW1 may further depend on whether the UE is configured or expected to be configured with only DRX cycle or with eDRX cycle (the DRX cycle may further be configured within the PTW of the eDRX cycle) for the UE operation in NW2. For example, the number of MGPs and/or one or more parameters (e.g., MGRP, MGL, etc.) defining one or more MGPs within the MGC for the same MCC may depend on whether the UE is configured with only DRX cycle or with eDRX cycle. For example, if the UE is configured with eDRX cycle, then within the PTW the UE may request larger number of MGPs compared to the case when the UE is configured with only DRX cycle. This may allow the UE to perform all the tasks within the PTW of the eDRX cycle without requiring the UE to wake up outside the PTW.

In accordance with an exemplary embodiment, for a UE capable of multi-USIM operation, NN1 in NW1 may configure the UE with MC configuration, and the UE may enter in low activity RRC state (e.g., in idle state) in NW2. In an embodiment, the UE may request NN1 to configure a certain number of MGPs (e.g., 4 gaps) to monitor signals in a cell in NW2 in low activity RRC state (e.g., in idle state). The UE may further send information about the mapping between the MCC (supported bands) and the MGC based on current measurement objects' configuration in NW2, e.g., the required MGPs may be based on signals to monitor in NW2. For example, the UE may indicate that if NN1 in NW1 releases the SCG, the UE may not need additional MGP for monitor signals in NW2 in low activity RRC state. NN1 in NW1 may decide whether to release the SCG and/or take other actions (e.g., releasing one or more CCs such as SCCs). NN1's decision may be based on, e.g., buffer size/amount of data to schedule, target/required/expected bit rate of the UE in NW1, etc. In an embodiment, if the UE releases the SCG and/or one or more CCs based on new/updated configuration received from NN1, then the UE may further request NN1 to allocate fewer (e.g., 1 MGP) or no MGP for monitor signals in NW2 in low activity RRC state.

In accordance with an exemplary embodiment, a method which may be performed by a network node to obtain a relation between gaps and multi-carrier configurations and use it for operational tasks is provided. In an embodiment, a network node such as NN1 serving or managing a UE may obtain a relation or mapping between a MGC for the UE to perform one or more procedures in NW2 (e.g., including the preferred configuration of each MGP) and a MCC for the UE to perform a multi-carrier operation in NW1. In another embodiment, NN1 may use the obtained information for performing one or more operational tasks. Examples of tasks may include:
configuring the UE with the MGC for enabling the UE to perform the one or more procedures in NW2 (e.g., for performing measurements, RA procedure, monitoring and/or receiving paging, SI, short messages, etc.).
configuring the UE with the MCC for enabling the UE to perform the multi-carrier (MC) operation in NW1 based on the obtained relation, e.g., requesting the UE to perform relax measurements, etc.

The examples of the relation or mapping between the MGC for the UE to perform one or more procedures in NW2 and the MCC for the UE to perform the MC operation in NW1, as described with respect to the UE previously (e.g., as shown in Tables 3-11), may also be applicable for the embodiments described with respect to the network node such as NN1.

In accordance with an exemplary embodiment, NN1 may obtain the information about the mapping or relation between the MGC for the UE to perform one or more procedures in NW2 and the MCC for the UE to perform the MC operation in NW1, based on one or more of the following mechanisms:
Pre-defined rule or information: In this mechanism, the relation or mapping may be pre-defined in the specification. In this case, NN1 may obtain it by loading or retrieving the relation or mapping from a memory of NN1.
Receiving from the UE: In this mechanism, the information about the mapping or relation may be received by NN1 from the UE, e.g., in UAI via RRC signaling. In an example, the information about the mapping or relation may be part of the UE capability information, e.g., static capability. In this case, the mapping may depend on the UE architecture (e.g., number of receive and/or transmit chains) and/or available resources (e.g., amount of available memory, processing resources, etc.). In another example, the mapping or the relation may be dynamically or semi-statically determined by the UE and reported to NN1. In this case, the mapping may depend on one or more of: currently available radio chain(s) in the UE (e.g., available number of receive and/or transmit chains), currently available resources (e.g., amount of available memory, processing resources, etc.), battery power (e.g., used batter power, remaining battery power, etc.) etc.

In accordance with an exemplary embodiment, NN1 may select or determine a set of MGCs and the corresponding set of the MCCs from the obtained mapping or relation based on one or more criterions. Examples of the criterions may include:
Amount of the data in the UE buffer size: For example, NN1 may select the MCC with larger number of CCs if the buffer size is above a certain threshold compared to the case when the buffer size is equal to or below the threshold.
Expected/requested UE data rate or throughput: For example, NN1 may select the MCC with larger number of CCs if the expected UE data rate is above a certain threshold compared to the case when the expected UE data rate is equal to or below the threshold.
Processing resources in NN1: For example, NN1 may select the MCC with larger number of CCs if the number of processing units and/or amount of memory are above their respective thresholds compared to the case when the number of processing units and/or amount of memory are equal to or below their respective thresholds.

In accordance with an exemplary embodiment, NN1 may configure the UE with the selected or the determined set of MGCs for performing procedures in NW2 and the corresponding set of the MCCs for performing MC operations in NW1.

In accordance with an exemplary embodiment, NN1 may configure the UE with the selected or the determined set of MGCs for performing procedures in NW2 and the corresponding set of the MCCs for performing MC operation in NW1, for a selected or a determined period of time (Td). The parameter Td may be determined based on the time period or timing related to the validity or applicability of the mapping or the relation between the MGC and the corresponding MCC. The validity time parameters (e.g., Tp, Ts, Te, etc.) as previously described with respect to the method for UE may also be applicable for the method for NN1. For example, NN1 may obtain the information about the validity time parameters by receiving them from the UE, e.g., in UAI via RRC signaling.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

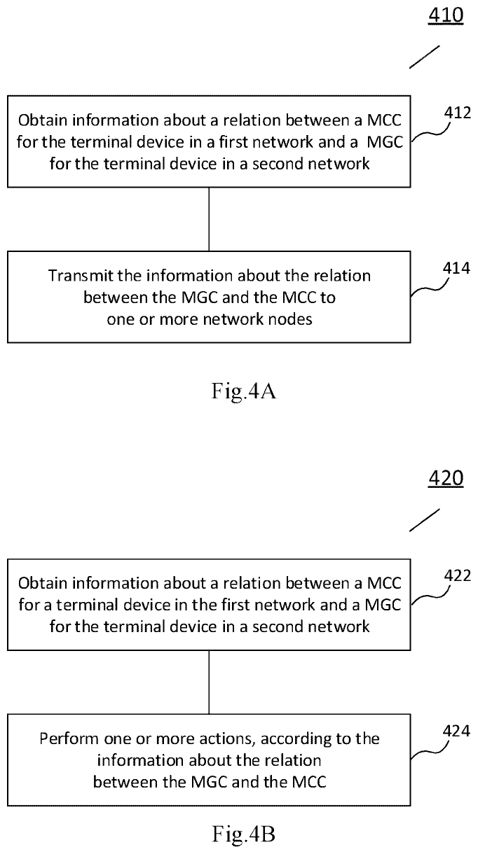

FIG. 4A is a flowchart illustrating a method 410 according to some embodiments of the present disclosure. The method 410 illustrated in FIG. 4A may be performed by a terminal device (e.g., a UE, a mobile terminal, etc.) or an apparatus communicatively coupled to the terminal device. In accordance with an exemplary embodiment, the terminal device may be capable of multi-USIM operation and/or be configured to operate in a multi-USIM scenario.

According to the exemplary method 410 illustrated in FIG. 4A, the terminal device may obtain information about a relation between a MCC for the terminal device in a first network (e.g., NW1 shown in FIG. 3) and a MGC for the terminal device for performing one or more procedures in a second network (e.g., NW2 shown in FIG. 3), as shown in block 412. In accordance with an exemplary embodiment, the terminal device may transmit the information about the relation between the MGC and the MCC to one or more network nodes, as shown in block 414. In an embodiment, the one or more network nodes may comprise at least a network node of the first network, e.g., NN1 shown in FIG. 3. In another embodiment, the one or more network nodes may further comprise another network node of the second network, e.g., NN2 shown in FIG. 3.

In accordance with an exemplary embodiment, the terminal device may obtain the information about the relation between the MGC and the MCC by using predefined information, and/or by determining the information about the relation between the MGC and the MCC autonomously.

In accordance with an exemplary embodiment, the information about the relation between the MGC and the MCC may be transmitted as part of UAI to the one or more network nodes by the terminal device.

In accordance with an exemplary embodiment, the information about the relation between the MGC and the MCC may be transmitted by the terminal device to the one or more network nodes proactively, and/or in response to receiving one or more requests from the one or more network nodes, and/or when one or more criterions are met.

In accordance with an exemplary embodiment, the information about the relation between the MGC and the MCC may comprise one or more of:
an identifier of predefined mapping between the MGC and the MCC;
MGC information for one or more procedures in the second network;
MCC information for one or more multi-carrier operations in the first network;
timing information of the relation between the MGC and the MCC; and
behavior information of the terminal device related to the timing information.

In accordance with an exemplary embodiment, the timing information of the relation between the MGC and the MCC may comprise one or more of the following parameters:
starting reference time when the relation between the MGC and the MCC is applicable;
a time period over which the relation between the MGC and the MCC is valid; and
ending reference time when the relation between the MGC and the MCC is no more applicable.

In accordance with an exemplary embodiment, the relation between the MGC and the MCC may be indicated by one or more of:
a mapping identifier indicating the relation between the MGC and the MCC;
an identifier of the MGC;
an identifier of the MCC;
a number of MGPs associated with the MGC;
a type of MGP;
a maximum number of CCs associated with the MCC;
a type of MCC;
a maximum number of bands associated with the MCC;
status information of one or more CCs associated with the MCC; and
status information of one or more bands associated with the MCC.

In accordance with an exemplary embodiment, the relation between the MGC and the MCC may be based at least in part on one or more of:
a DRX cycle configuration with which the terminal device is expected to operate in the second network;
a type of a low activity RRC state with which the terminal device is expected to operate in the second network;
whether the terminal device is expected to be configured with only DRX cycle or with eDRX cycle in the second network; and
a measurement object configuration of the terminal device in the second network.

In accordance with an exemplary embodiment, the terminal device may provide configuration information per MGC to a network node of the first network explicitly or implicitly.

In accordance with an exemplary embodiment, the terminal device may determine that the terminal device is configured with one or more measurement objects on one or more carrier frequencies and/or one or more procedures in a cell of the second network.

In accordance with an exemplary embodiment, the terminal device may receive MCC information from a network node of the first network. In an embodiment, the terminal device may set up one or more cells in the first network to perform one or more multi-carrier operations, according to the MCC information.

In accordance with an exemplary embodiment, the terminal device may transmit, to a network node of the first network, a request for configuring the terminal device with one or more MGPs for one or more procedures in the second network.

In accordance with an exemplary embodiment, the terminal device may receive MGC information from a network node of the first network. In an embodiment, the terminal device may set up one or more MGPs to perform one or more procedures in the second network, according to the MGC information.

FIG. 4B is a flowchart illustrating a method 420 according to some embodiments of the present disclosure. The method 420 illustrated in FIG. 4B may be performed by a network node (e.g., a base station, an access point, etc.) of a first network or an apparatus communicatively coupled to the network node. In accordance with an exemplary embodiment, the network node may be configured to support cellular coverage and service provision to one or more terminal devices which may be configured to operate in a multi-USIM scenario. In accordance with an exemplary embodiment, the network node may support multi-USIM operation of the terminal device.

According to the exemplary method 420 illustrated in FIG. 4B, the network node may obtain information about a relation between a MCC for a terminal device (e.g., the terminal device as described with respect to FIG. 4A) in the first network and a MGC for the terminal device for performing one or more procedures in a second network, as shown in block 422. In accordance with an exemplary embodiment, the network node may perform one or more actions, according to the information about the relation between the MGC and the MCC, as shown in block 424.

In accordance with an exemplary embodiment, the relation between the MGC and the MCC as described with respect to FIG. 4B may correspond to the relation between the MGC and the MCC as described with respect to FIG. 4A. Thus, the relation between the MGC and the MCC according to the method 410 and the method 420 may have the same or similar contents and/or feature elements.

In accordance with an exemplary embodiment, the information about the relation between the MGC and the MCC as described with respect to FIG. 4B may correspond to the information about the relation between the MGC and the MCC as described with respect to FIG. 4A. Thus, the information about the relation between the MGC and the MCC according to the method 410 and the method 420 may have the same or similar contents and/or feature elements.

In accordance with an exemplary embodiment, the one or more actions may comprise: applying one or more MGCs to the terminal device to enable the terminal device to perform one or more procedures in the second network; and/or applying one or more MCCs to the terminal device to enable the terminal device to perform one or more multi-carrier operations in the first network.

In accordance with an exemplary embodiment, the network node may obtain the information about the relation between the MGC and the MCC by using predefined information, and/or by receiving the information about the relation between the MGC and the MCC from the terminal device.

In accordance with an exemplary embodiment, the information about the relation between the MGC and the MCC may be received as part of UAI by the network node from the terminal device.

In accordance with an exemplary embodiment, the network node may obtain configuration information per MGC from the terminal device explicitly or implicitly.

In accordance with an exemplary embodiment, the network node may determine a set of MGCs and a set of MCCs corresponding to the set of MGCs, according to the information about the relation between the MGC and the MCC. In an embodiment, the set of the MGCs is to be configured to the terminal device for performing one or more procedures in the second network, and the set of the MCCs is to be configured to the terminal device for performing one or more multi-carrier operations in the first network.

In accordance with an exemplary embodiment, the determination of the set of the MGCs and the set of the MCCs may be made by the network node based at least in part on one or more of: an amount of data in a buffer for the terminal device; expected data rate and/or throughput of the terminal device; and processing resources of the network node.

In accordance with an exemplary embodiment, the network node may transmit MGC information to the terminal device to configure the terminal device with the set of the MGCs. Alternatively or additionally, the network node may transmit MCC information to the terminal device to configure the terminal device with the set of the MCCs. In an embodiment, the configuration of the set of the MCCs and/or the configuration of the set of the MCCs of the terminal device may be valid within a predetermined period of time.

In accordance with an exemplary embodiment, the network node may receive, from the terminal device, a request for configuring the terminal device with one or more MGPs for one or more procedures in the second network.

The various blocks shown in FIGS. 4A-4B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

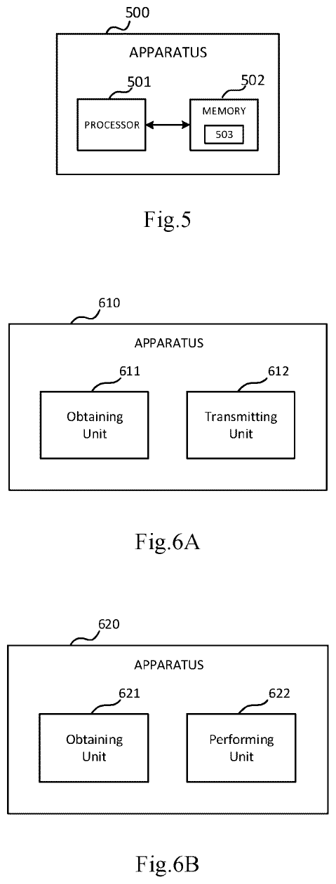

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a terminal device as described with respect to FIG. 4A, or a network node as described with respect to FIG. 4B. In such cases, the apparatus 500 may be implemented as a terminal device as described with respect to FIG. 4A, or a network node as described with respect to FIG. 4B.

In some implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

FIG. 6A is a block diagram illustrating an apparatus 610 according to some embodiments of the present disclosure. As shown in FIG. 6A, the apparatus 610 may comprise an obtaining unit 611 and a transmitting unit 612. In an exemplary embodiment, the apparatus 610 may be implemented in a terminal device such as a UE. The obtaining unit 611 may be operable to carry out the operation in block 412, and the transmitting unit 612 may be operable to carry out the operation in block 414. Optionally, the obtaining unit 611 and/or the transmitting unit 612 may be operable to carry out more or less operations to implement the proposed methods according to the exemplary embodiments of the present disclosure. In an embodiment, the apparatus 610 may further comprise a receiving unit (not shown in FIG. 6A) which may be operable to receive information from one or more other devices (e.g., a network node, another terminal device, etc.).

FIG. 6B is a block diagram illustrating an apparatus 620 according to some embodiments of the present disclosure. As shown in FIG. 6B, the apparatus 620 may comprise an obtaining unit 621 and a performing unit 622. In an exemplary embodiment, the apparatus 620 may be implemented in a network node such as a base station. The obtaining unit 621 may be operable to carry out the operation in block 422, and the performing unit 622 may be operable to carry out the operation in block 424. Optionally, the obtaining unit 621 and/or the performing unit 622 may be operable to carry out more or less operations to implement the proposed methods according to the exemplary embodiments of the present disclosure. In an embodiment, the apparatus 620 may further comprise a transmitting unit and/or a receiving unit (not shown in FIG. 6B) which may be operable respectively to transmit information to and/or receive information from one or more other devices (e.g., a terminal device, another network node, etc.).

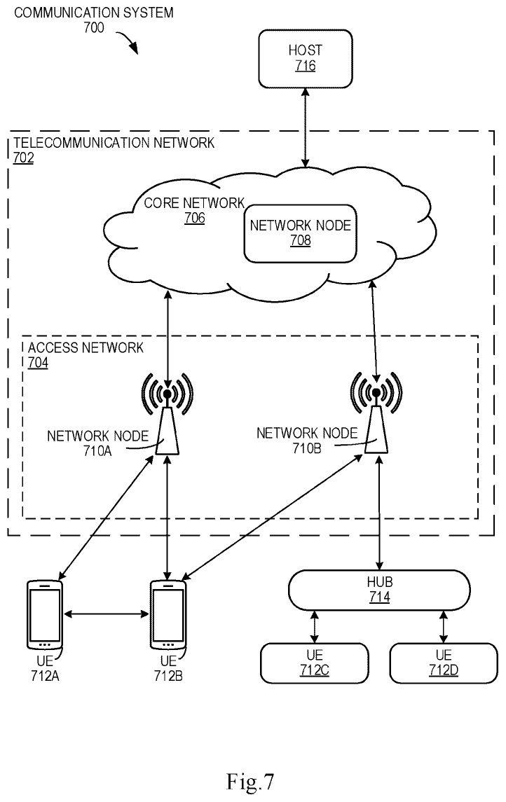

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710A and 710B (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements s 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and network node 710B, but which is additionally capable of operating as a communication start and/or end point for certain data channels.

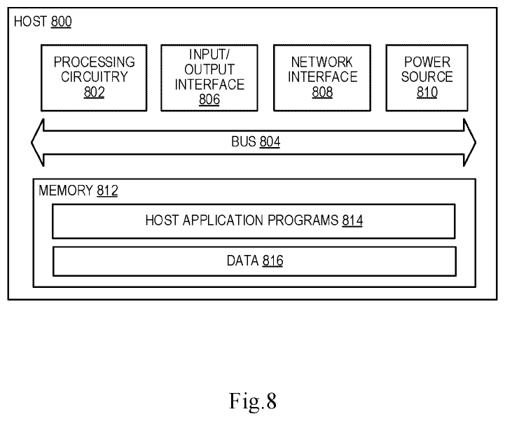

FIG. 8 is a block diagram of a host 800, which may be an embodiment of the host 716 of FIG. 7, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6A-6B, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

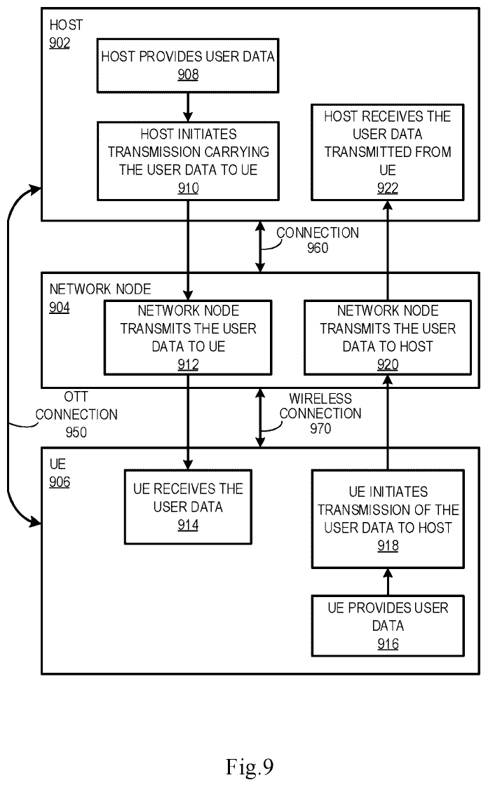

FIG. 9 shows a communication diagram of a host 902 communicating via a network node 904 with a UE 906 over a partially wireless connection in accordance with some embodiments. Example implementations, in accordance with various embodiments, of the UE (such as a UE 712A of FIG. 7 and/or apparatus 610 of FIG. 6A), network node (such as network node 710A of FIG. 7 and/or apparatus 620 of FIG. 6B), and host (such as host 716 of FIG. 7 and/or host 800 of FIG. 8) discussed in the preceding paragraphs will now be described with reference to FIG. 9.

Like host 800, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 706 of FIG. 7) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve the traffic performance such as data rate, latency and power consumption, and thereby provide benefits such as lower complexity, reduced user waiting time, relaxed restriction on file size, improved content resolution, better responsiveness, extended battery lifetime, etc.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

According to some exemplary embodiments, there is provided a host configured to operate in a communication system to provide an over-the-top (OTT) service. The host may comprise: processing circuitry configured to provide user data; and a network interface configured to initiate transmission of the user data to a network node in a cellular network for transmission to a user equipment (UE). The network node may have a communication interface and processing circuitry, and the processing circuitry of the network node may be configured to perform operations of the exemplary method 420 as described with respect to FIG. 4B to transmit the user data from the host to the UE. In an embodiment, the processing circuitry of the host may be configured to execute a host application that provides the user data, and the UE may comprise processing circuitry configured to execute a client application associated with the host application to receive the transmission of user data from the host.

According to some exemplary embodiments, there is provided a method implemented in a host configured to operate in a communication system that further includes a network node and a user equipment (UE). The method may comprise: providing user data for the UE; and initiating a transmission carrying the user data to the UE via a cellular network comprising the network node. The network node may perform operations of the exemplary method 420 as described with respect to FIG. 4B to transmit the user data from the host to the UE. In an embodiment, the method may further comprise: at the network node, transmitting the user data provided by the host for the UE. In another embodiment, the user data may be provided at the host by executing a host application that interacts with a client application executing on the UE, the client application being associated with the host application.

According to some exemplary embodiments, there is provided a communication system configured to provide an over-the-top service. The communication system may comprise a host comprising: processing circuitry configured to provide user data for a user equipment (UE), the user data being associated with the over-the-top service; and a network interface configured to initiate transmission of the user data toward a cellular network node for transmission to the UE. The network node may have a communication interface and processing circuitry, and the processing circuitry of the network node may be configured to perform operations of the exemplary method 420 as described with respect to FIG. 4B to transmit the user data from the host to the UE. In an embodiment, the communication system may further comprise the network node and/or the user equipment. In another embodiment, the processing circuitry of the host may be configured to execute a host application, thereby providing the user data; and the host application may be configured to interact with a client application executing on the UE, the client application being associated with the host application.

According to some exemplary embodiments, there is provided a host configured to operate in a communication system to provide an over-the-top (OTT) service. The host may comprise: processing circuitry configured to initiate receipt of user data; and a network interface configured to receive the user data from a network node in a cellular network. The network node may have a communication interface and processing circuitry, and the processing circuitry of the network node may be configured to perform operations of the exemplary method 420 as described with respect to FIG. 4B to receive the user data from the UE for the host. In an embodiment, the processing circuitry of the host may be configured to execute a host application, thereby providing the user data; and the host application may be configured to interact with a client application executing on the UE, the client application being associated with the host application. In another embodiment, the initiating receipt of the user data may comprise requesting the user data.

According to some exemplary embodiments, there is provided a method implemented by a host configured to operate in a communication system that further includes a network node and a user equipment (UE). The method may comprise: at the host, initiating receipt of user data from the UE, the user data originating from a transmission which the network node has received from the UE. The network node may perform operations of the exemplary method 420 as described with respect to FIG. 4B to receive the user data from the UE for the host. In an embodiment, the method may further comprise: at the network node, transmitting the received user data to the host.

According to some exemplary embodiments, there is provided a host configured to operate in a communication system to provide an over-the-top (OTT) service. The host may comprise: processing circuitry configured to provide user data; and a network interface configured to initiate transmission of the user data to a cellular network for transmission to a user equipment (UE). The UE may comprise a communication interface and processing circuitry, and the communication interface and processing circuitry of the UE may be configured to perform operations of the exemplary method 410 as described with respect to FIG. 4A to receive the user data from the host. In an embodiment, the cellular network may further include a network node configured to communicate with the UE to transmit the user data to the UE from the host. In another embodiment, the processing circuitry of the host may be configured to execute a host application, thereby providing the user data; and the host application may be configured to interact with a client application executing on the UE, the client application being associated with the host application.

According to some exemplary embodiments, there is provided a method implemented by a host operating in a communication system that further includes a network node and a user equipment (UE). The method may comprise: providing user data for the UE; and initiating a transmission carrying the user data to the UE via a cellular network comprising the network node. The UE may perform operations of the exemplary method 410 as described with respect to FIG. 4A to receive the user data from the host. In an embodiment, the method may further comprise: at the host, executing a host application associated with a client application executing on the UE to receive the user data from the UE. In another embodiment, the method may further comprise: at the host, transmitting input data to the client application executing on the UE, the input data being provided by executing the host application. The user data may be provided by the client application in response to the input data from the host application.

According to some exemplary embodiments, there is provided a host configured to operate in a communication system to provide an over-the-top (OTT) service. The host may comprise: processing circuitry configured to utilize user data; and a network interface configured to receipt of transmission of the user data to a cellular network for transmission to a user equipment (UE). The UE may comprise a communication interface and processing circuitry, and the communication interface and processing circuitry of the UE may be configured to perform operations of the exemplary method 410 as described with respect to FIG. 4A to transmit the user data to the host. In an embodiment, the cellular network may further include a network node configured to communicate with the UE to transmit the user data from the UE to the host. In another embodiment, the processing circuitry of the host may be configured to execute a host application, thereby providing the user data, and the host application may be configured to interact with a client application executing on the UE, the client application being associated with the host application.

According to some exemplary embodiments, there is provided a method implemented by a host configured to operate in a communication system that further includes a network node and a user equipment (UE). The method may comprise: at the host, receiving user data transmitted to the host via the network node by the UE. The UE may perform operations of the exemplary method 410 as described with respect to FIG. 4A to transmit the user data to the host. In an embodiment, the method may further comprise: at the host, executing a host application associated with a client application executing on the UE to receive the user data from the UE. In another embodiment, the method may further comprise: at the host, transmitting input data to the client application executing on the UE, the input data being provided by executing the host application. The user data may be provided by the client application in response to the input data from the host application.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device capable of being served by two cells respectively belonging to two networks, comprising:
obtaining information about a relation between a multi-carrier configuration, MCC, for the terminal device in a first network and a measurement gap configuration, MGC, for the terminal device for performing one or more procedures in a second network; and
transmitting the information about the relation between the MGC and the MCC to a network node in the first network.

2. The method according to claim 1, wherein the terminal device obtains the information about the relation between the MGC and the MCC by one or more of:
using predefined information; and
determining the information about the relation between the MGC and the MCC autonomously.

3. The method according to claim 1, further comprising: transmitting the information about the relation between the MGC and the MCC in user equipment assistance information, UAI, to a network node in the second network.

4. The method according to claim 1, wherein transmitting the information about the relation between the MGC and the MCC is performed by the terminal device proactively, in response to receiving one or more requests from the one or more network nodes, and/or when one or more criterions are met.

5. The method according to claim 1, wherein the information about the relation between the MGC and the MCC comprises one or more of:
MGC information for one or more procedures in the second network;
MCC information for one or more multi-carrier operations in the first network;
timing information of the relation between the MGC and the MCC; and
behavior information of the terminal device related to the timing information, wherein the timing information comprises one or more of the following parameters:
starting reference time when the relation between the MGC and the MCC is applicable;
a time period over which the relation between the MGC and the MCC is valid; and
ending reference time when the relation between the MGC and the MCC is no more applicable.

6. The method according to claim 1, wherein the relation between the MGC and the MCC is indicated by one or more of:
a mapping identifier indicating the relation between the MGC and the MCC;
an identifier of the MGC;
an identifier of the MCC;
a maximum number of component carriers, CCs, associated with the MCC;
a type of MCC;
a maximum number of bands associated with the MCC;
status information of one or more CCs associated with the MCC; and
status information of one or more bands associated with the MCC.

7. The method according to claim 1, wherein
obtaining information about the relation between the MGC and the MCC is based at least in part on one or more of:
a discontinuous reception, DRX, cycle configuration with which the terminal device is expected to operate in the second network;
a type of a low activity radio resource control, RRC, state with which the terminal device is expected to operate in the second network;
whether the terminal device is expected to be configured with only DRX cycle or with extended discontinuous reception, eDRX, cycle in the second network; and
a measurement object configuration of the terminal device in the second network.

8. The method according to claim 1, further comprising:
providing configuration information per MGC to the network node of the first network explicitly or implicitly.

9. The method according to claim 1, further comprising:
determining that the terminal device is configured with one or more measurement objects on one or more carrier frequencies and/or one or more procedures in a cell of the second network.

10. The method according to claim 1, further comprising:
receiving MCC information from the network node of the first network;
transmitting, to the network node of the first network, a request for configuring the terminal device with one or more MGPs for one or more procedures in the second network;
receiving MGC information from a network node of the first network; and
setting up one or more MGPs to perform one or more procedures in the second network, according to the MGC information.

11. The method according to claim 1, wherein the terminal device is capable of multi-universal subscriber identity module, multi-USIM, operation.

12. A terminal device capable of being served by two cells respectively belonging to two networks, comprising:
one or more processors; and
one or more memories comprising computer program codes,
the one or more memories and the computer program codes configured to, with the one or more processors, cause the terminal device at least to:
obtain information about a relation between a multi-carrier configuration, MCC, for the terminal device in a first network and a measurement gap configuration, MGC, for the terminal device for performing one or more procedures in a second network; and
transmit the information about the relation between the MGC and the MCC to a network node in the first network.

13. The terminal device according to claim 12, wherein the one or more memories and the computer program codes are configured to, with the one or more processors, cause the terminal device to perform the method according to any one of claim 2.

14. (canceled)

15. A method performed by a network node of a first network, comprising:
obtaining information about a relation between a multi-carrier configuration, MCC, for a terminal device in the first network and a measurement gap configuration, MGC, for the terminal device for performing one or more procedures in a second network, wherein the terminal device is capable of being served by two cells respectively belonging to the first network and the second network; and
performing, according to the information about the relation between the MGC and the MCC, one or more actions of:
applying one or more MGCs to the terminal device to enable the terminal device to perform one or more procedures in the second network; and
applying one or more MCCs to the terminal device to enable the terminal device to perform one or more multi-carrier operations in the first network.

16. The method according to claim 15, wherein the information about the relation between the MGC and the MCC is received as part of user equipment assistance information, UAI, from the terminal device.

17. The method according to claim 15, wherein the information about the relation between the MGC and the MCC comprises one or more of:
an identifier of predefined mapping between the MGC and the MCC;
MGC information for one or more procedures in the second network;
MCC information for one or more multi-carrier operations in the first network;
timing information of the relation between the MGC and the MCC; and
behavior information of the terminal device related to the timing information, wherein the timing information of the relation between the MGC and the MCC comprises one or more of the following parameters:
starting reference time when the relation between the MGC and the MCC is applicable;
a time period over which the relation between the MGC and the MCC is valid; and
ending reference time when the relation between the MGC and the MCC is no more applicable.

18. The method according to claim 15, wherein the relation between the MGC and the MCC is indicated by one or more of:
a mapping identifier indicating the relation between the MGC and the MCC;
an identifier of the MGC;
an identifier of the MCC;
a number of measurement gap patterns, MGPs, associated with the MGC;
a type of MGP;
a maximum number of component carriers, CCs, associated with the MCC;
a type of MCC;
a maximum number of bands associated with the MCC;
status information of one or more CCs associated with the MCC; and
status information of one or more bands associated with the MCC.

19. The method according to claim 15, further comprising:
determining, a set of MGCs and a set of MCCs corresponding to the set of MGCs, according to the information about the relation between the MGC and the MCC, based at least in part on one or more of:
an amount of data in a buffer for the terminal device;
expected data rate and/or throughput of the terminal device; and
processing resources of the network node;
wherein the set of the MGCs is to be configured to the terminal device for performing one or more procedures in the second network, and the set of the MCCs is to be configured to the terminal device for performing one or more multi-carrier operations in the first network.

20. The method according to claim 19, further comprising:
receiving, from the terminal device, a request for configuring the terminal device with one or more MGPs for one or more procedures in the second network;
transmitting MGC information to the terminal device to configure the terminal device with the set of the MGCs; and/or
transmitting MCC information to the terminal device to configure the terminal device with the set of the MCCs, wherein the configuration of the set of the MCCs and/or the configuration of the set of the MCCs of the terminal device are valid within a predetermined period of time.

21-22. (canceled)

23. A computer-readable medium having computer program codes embodied thereon which, when executed on a computer, cause the computer to perform any step of the method according to claim 15.
